(19) United States
(12) Patent Application Publication
(10) Pub. No.: US 2018/0050359 A1
(43) Pub. Date: Feb. 22, 2018

(54) APPARATUS FOR CONTAINING AND DISPENSING FLUIDS UNDER PRESURE

(71) Applicants: Chu-Hui WANG, New Taipei City (TW); Hau-Ming CHANG, New Taipei City (TW); Wei-Hsuan TSENG, New Taipei City (TW); Feng-Ching OU, New Taipei City (TW)

(72) Inventors: Hau-Ming CHANG, New Taipei City (TW); Chu-Hui WANG, New Taipei City (TW); Szu-Han HUANG, Taipei City (TW); Tyzz-Chuan TSENG, New Taipei City (TW)

(73) Assignees: Chu-Hui WANG, New Taipei City (TW); Hau-Ming CHANG, New Taipei City (TW); Wei-Hsuan TSENG, New Taipei City (TW); Feng-Ching OU, New Taipei City (TW)

(21) Appl. No.: 15/393,122

(22) Filed: Dec. 28, 2016

(30) Foreign Application Priority Data
Aug. 16, 2016 (TW) 105212427

(51) Int. Cl. B05B 11/00; B65D 23/02; B65D 1/02; A45D 34/00

(52) U.S. Cl. CPC B05B 11/0043; B65D 23/02; B05B 11/3045; A45D 34/00; B65D 1/023

(57) ABSTRACT

An apparatus for containing and dispensing fluids under pressure has an inner bladder including multiple ribs. Sterilized liquid may be stored in the chamber without leaking out and being contaminated by bacteria outside. Besides, the ribs reinforce the structural strength of the inner bladder in the longitudinal direction so that the inner bladder is not recovered by the gravity after transversely compressed, and thus the access to the liquid is convenient. Further, the overall structure of the apparatus is simplified, and the production and the use of the apparatus are handy.

### CROSS-REFERENCE TO RELATED APPLICATION(S)

This application is based upon and claims priority under 35 U.S.C. 119(a) from Taiwan Patent Application No. 105212427 filed on Aug. 16, 2016, which is hereby specifically incorporated herein by this reference thereto.

### BACKGROUND

### 1. Technical Field

The present invention relates to an apparatus for containing and dispensing fluids, and more specifically to an apparatus for containing and dispensing fluids free of antioxidants or preservatives under pressure to prevent air from flowing into a fluid-containing chamber in the apparatus.

### 2. Description of the Prior Art(s)

With the advance of science and technology and the improvement in living standards, skincare has gained much more attention recently, and thereby spurring the flourishing development of cosmetics industry. For convenience in use, cosmetic products are commonly filled in apparatuses for containing and dispensing fluids under pressure.

With reference to FIG. 6, a conventional apparatus 90 for containing and dispensing fluids under pressure comprises a spout 91, a container 92 having a softening point around 50° C., and a bottom cover 93. The spout 91 is mounted on the top portion of the container 92. The bottom portion of the container 92 is covered with the bottom cover 93. A piston 921 is disposed inside the container 92. The rim of the piston 921 contacts and is movable relative to the inner surface of the container 92. A chamber 94 for containing cosmetic liquid is formed between the spout 91 and the piston 921.

A dip tube 911 extends downwardly into the chamber 94 from the spout 91. The bottom end of the dip tube 911 is dipped in the cosmetic liquid. The bottom cover 93 comprises a vent hole 931. In use, the spout 93 is depressed to allow the cosmetic liquid to flow from the chamber 94 into the dip tube 911 and then out of the spout 93. When the cosmetic liquid flows out from the chamber 94, the ambient pressure pushes the piston 921 upward to reduce the volume of the chamber 94 so as to equalize the pressures within the chamber 94 and the ambient pressure. Meanwhile, the rest of the cosmetic liquid in the chamber 94 is moved upward by the piston 921. When all of the cosmetic liquid flows out, the piston 921 is positioned at the uppermost of the chamber 94.

However, the piston 921 must be movable relative to the container 92 such that the rim of the piston 921 cannot tightly and hermetically abut the inner surface of the container 92. The ambient air may enter the unsealed chamber 94 through the gap between the rim of the piston 921 and the inner surface of the container 92. Thus, the cosmetic liquid may leak out from the chamber 94 via the gap, causing a waste of the cosmetic liquid.

Besides, bacteria may enter the chamber 94 via the gap with air to contaminate the cosmetic liquid and damage the health of the user. As the softening point of the container 92 is around 50° C., the container 92 cannot be disinfected by water at a temperature higher than 50° C. Accordingly, to prevent the growth of bacteria in the cosmetic liquid, the cosmetic liquid must contain antioxidants or preservatives. But the antioxidants and preservatives may cause allergic reactions and cancer.

Further, the design of the piston 921 inside the container 92 results in the complicate structure and the increased cost of the conventional apparatus 90, which thereby decreases the profit of selling the cosmetic liquid. Once the cosmetic liquid is used up, the conventional apparatus 90 is immediately disposed of. That is, the conventional apparatus 90 having the complicate structure is only used once before disposal, which is definitely a waste of resource.

To overcome the shortcomings, an apparatus for containing and dispensing fluids under pressure to mitigate or obviate the aforementioned problems is provided.

### SUMMARY

An objective of the present invention is to provide an apparatus for containing and dispensing fluids under pressure to overcome the technical limitation in preventing bacteria from entering a chamber filled with a liquid with the air, preventing the liquid in the chamber from leaking out, lowering manufacturing cost, increasing profit in selling a cosmetic liquid, and economizing resources.

In accordance with an embodiment of the present invention, the apparatus for containing and dispensing fluids under pressure comprises a bottle, an airless dispensing pump, and an inner bladder. The bottle comprises a top opening, a bottom opening, and a room connected between the top opening and the bottom opening. The airless dispensing pump is mounted on the top opening and fixedly connected with the top opening. The inner bladder is disposed in the room and comprises a bladder neck connected with the airless dispensing pump, a bottom part being sealed, a peripheral part disposed between the bladder neck and the bottom part, and a chamber. The peripheral part comprises multiple ribs extending longitudinally between the bladder neck and the bottom part. The chamber is surrounded by the bladder neck, the bottom part, and the peripheral part. The bladder neck, the bottom part, and the peripheral part are formed as one piece.

Sterilized liquid may be stored in the chamber without leaking out and the liquid is prevented from contacting and contaminated by bacteria outside the apparatus. Besides, the ribs strengthen the structural strength of the inner bladder in the longitudinal direction so that the inner bladder is not recovered by the gravity after transversely compressed, thereby facilitating easy access to the liquid.

In accordance with an embodiment, the bladder neck is mounted through the top opening, and the chamber is connected with the airless dispensing pump via the bladder neck.

In accordance with an embodiment, the airless dispensing pump comprises a conduit inserted into the room, fixed with the bladder neck, and inserted into the chamber. Accordingly, the liquid in the chamber is allowed to flow out via the conduit and the spout of the airless dispensing pump after the airless dispensing pump is depressed.

In accordance with an embodiment, the apparatus for containing and dispensing fluids under pressure further comprises a bottom cover covering the bottom opening and including at least one vent hole, and each of the at least one vent hole is connected with the room. Accordingly, the inner bladder is protected by the bottom cover from being punctured. Besides, When the airless dispensing pump is actuated and pushed, the air flows into the room via the at least one vent hole to compress the inner bladder, thereby enhancing the flowing of the liquid out of the chamber.

In accordance with an embodiment, the inner bladder is made of a material that is plastic and thermostable. The material may be poly vinyl chloride (PVC) or polypropylene (PP). Accordingly, the inner bladder may be compressed by the ambient air and gradually decrease the volume of the chamber so as to enhance the flowing of the rest of the liquid out of the chamber.

In accordance with an embodiment, the ribs protrude away from the chamber.

In accordance with an embodiment, each of the ribs has a width gradually decreased from a middle section of each of the ribs towards the bladder neck and the bottom part. As the ribs and the inner bladder are formed as one piece, the structural strength of the inner bladder in the longitudinal direction is further enhanced, thereby further preventing the longitudinal compression of the inner bladder.

In accordance with an embodiment, the bottle comprises a bottle neck surrounding the top opening and comprising an outer surface and an outer thread. The outer thread is formed on the outer surface. The airless dispensing pump comprises an inner surface and an inner thread formed on the inner surface. The inner thread matches the outer thread. Also, the airless dispensing pump and the bottle are threaded together by the inner thread and the outer thread. Accordingly, the replacement of the inner bladder is convenient and the rest of the components of the apparatus, such as the airless dispensing pump, the bottle, and the bottom cover, are reusable. Thus, the resources are saved and the apparatus is environmentally friendly.

Other objectives, advantages, and novel features of the embodiments of the present invention will become more apparent from the following detailed description when taken in conjunction with the accompanying drawings.

### BRIEF DESCRIPTION OF THE DRAWINGS

FIG. 1 is an exploded perspective view of a first embodiment of an apparatus for containing and dispensing fluids under pressure in accordance with the present invention;

FIG. 2 is a partially cross-sectional side view of the apparatus for containing and dispensing fluids under pressure in FIG. 1;

FIG. 3 is a cross-sectional top view of an inner bladder of the apparatus for containing and dispensing fluids under pressure in FIG. 1;

FIG. 4 is an operational cross-sectional side view of the apparatus for containing and dispensing fluids under pressure in FIG. 1, showing an actuated state;

FIG. 5 is an exploded perspective view of a second embodiment of an apparatus for containing and dispensing fluids under pressure in accordance with the present invention; and

FIG. 6 is a partially cross-sectional side view of a conventional apparatus for containing and dispensing fluids under pressure in accordance with the prior art.

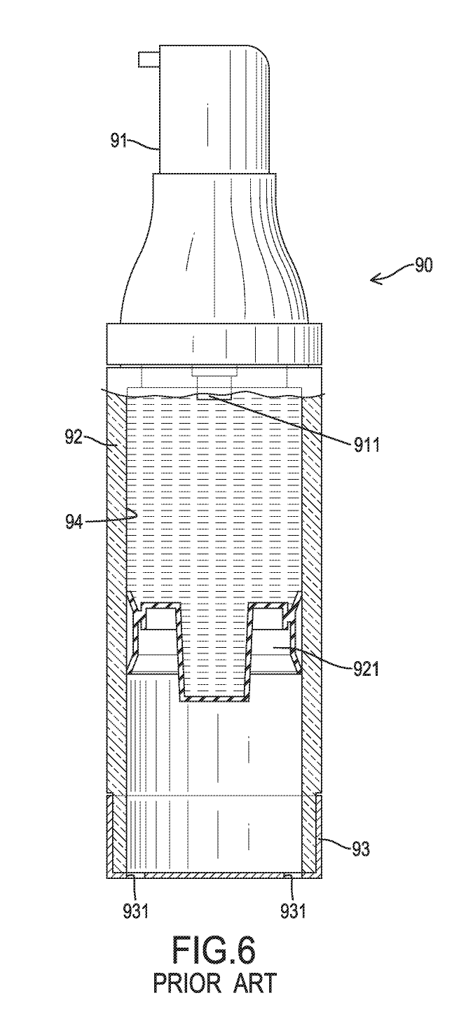

### DETAILED DESCRIPTION

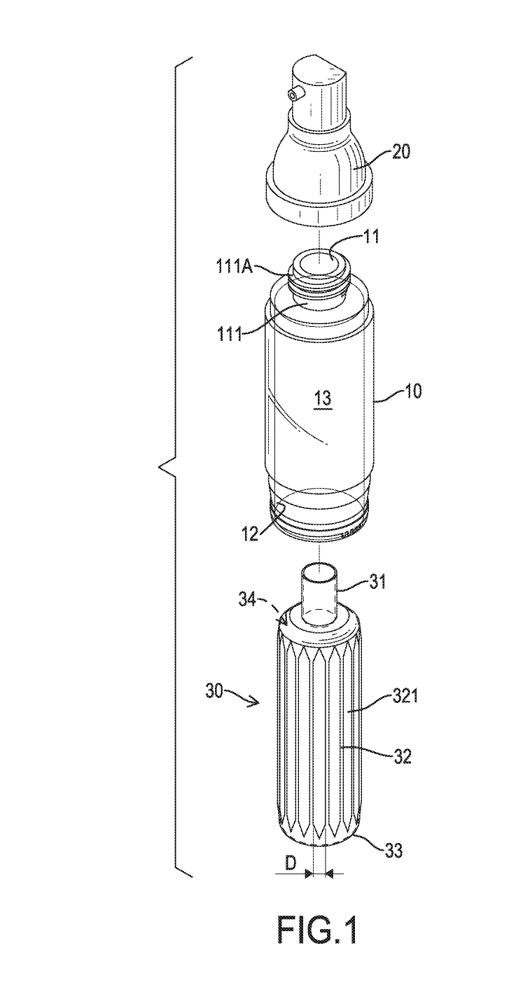

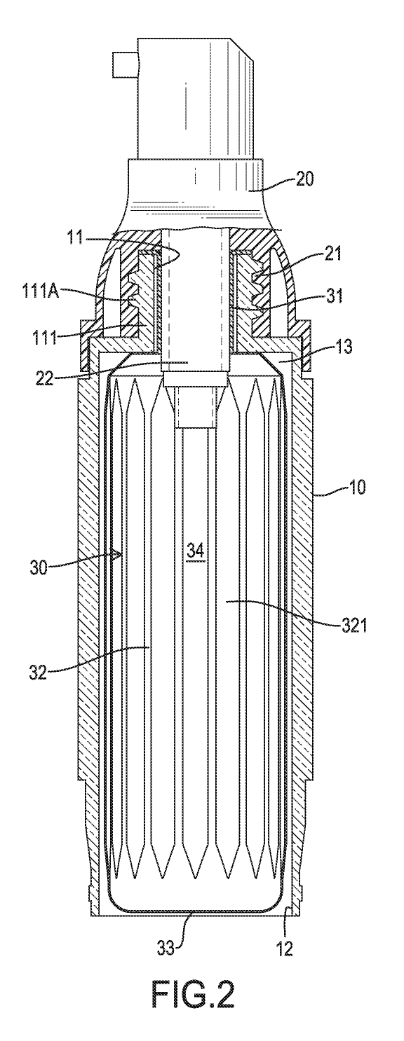

With reference to FIGS. 1 and 2, in a first embodiment, an apparatus for containing and dispensing fluids under pressure in accordance with the present invention comprises a bottle 10, an airless dispensing pump 20, and an inner bladder 30.

With reference to FIGS. 1 and 2, the bottle 10 comprises a top opening 11, a bottom opening 12, and a room 13. The top opening 11 and the bottom opening 12 are respectively disposed at the top side of the room 13 and the bottom side of the room 13. The room 13 is connected between the top opening 11 and the bottom opening 12. Specifically, the bottle 10 comprises a bottle neck 111 surrounding the top opening 11. The bottle neck 111 comprises an outer surface and an outer thread 111A. The outer thread 111A is formed on the outer surface for mounting the airless dispensing pump 20.

With reference to FIGS. 1 and 2, the airless dispensing pump 20 is mounted at the top opening 11. Specifically, the airless dispensing pump 20 comprises an inner surface and an inner thread 21 formed on the inner surface and matching the outer thread 111A. The airless dispensing pump 20 is mounted on and fixed with the bottle 10 by combining the inner thread 21 and the outer thread 111A. In other words, the airless dispensing pump 20 and the bottle 10 are threaded together.

With reference to FIGS. 1 and 2, the airless dispensing pump 20 comprises a bottom side facing the bottle and a conduit 22 disposed at the bottom side. The conduit 22 is inserted into the room 13 via the top opening 11.

With reference to FIGS. 1 and 2, the inner bladder 30 is made of plastic materials that are thermostable. The inner bladder 30 is disposed in the room 13. The inner bladder 30 comprises a bladder neck 31, a peripheral part 32, a bottom part 33, and a chamber 34. The bladder neck 31 and the bottom part 33 are respectively disposed at the top side of the peripheral part 32 and the bottom side of the peripheral part 32. The bladder neck 31, the peripheral part 32, and the bottom part 33 are formed as one piece. The chamber 34 is surrounded by the bladder neck 31, the peripheral part 32, and the bottom part 33. Specifically, the bladder neck 31 is positioned in the top opening 11. The peripheral part 32 is positioned in the room 13. The bottom part 33 is positioned in the bottom opening 12.

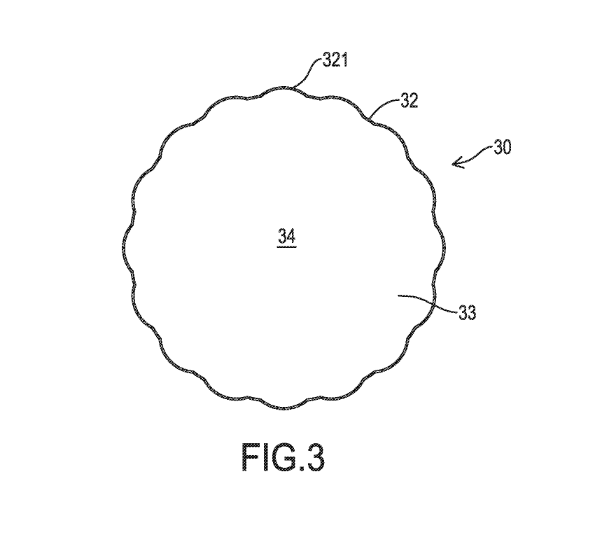

With reference to FIGS. 1 to 3, the shape of the bladder neck 31 matches the shape of the top opening 11. An inner face of the bladder neck 31 is fixed with the conduit 22, so that the conduit 22 is inserted into the chamber 34 via the bladder neck 31 and connected with the chamber 34. The shape of the bottom part 33 matches the shape of the bottom opening 12. The bottom part 33 is sealed so as to fill fluids, such as lotion or emulsion, in the chamber 34. The peripheral part 32 comprises multiple ribs 321 extending longitudinally between the bladder neck 31 and the bottom part 33. Accordingly, the cross-section of the peripheral part 32 is a wavy structure. The ribs 321 protrude away from the chamber 34. Each of the ribs 321 has a width gradually decreased from a middle section of each of the ribs towards the bladder neck 31 and the bottom part 33.

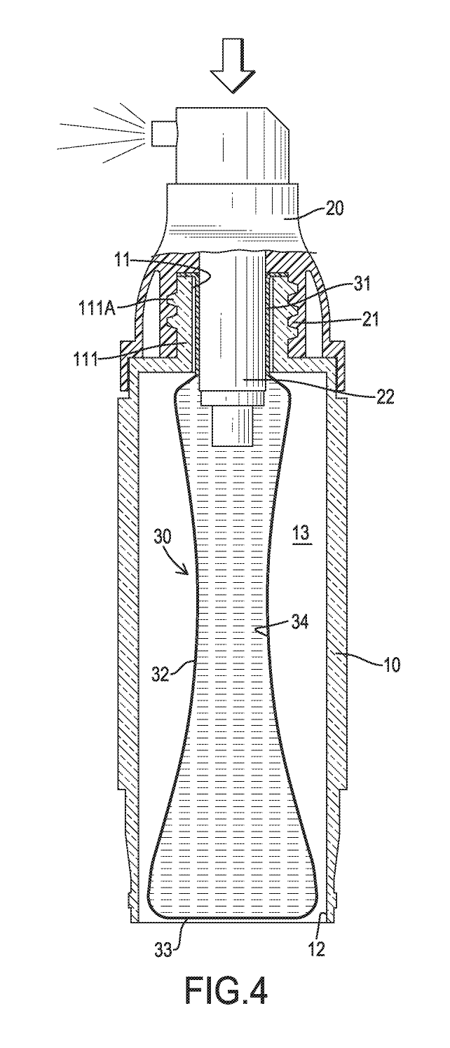

With reference to FIG. 2, the inner bladder 30 is filled with liquid. With reference to FIG. 4, after the airless dispensing pump 20 is pushed many times to allow the liquid to flow out from the chamber 34 of the inner bladder 30, the liquid contained in the inner bladder 30 is reduced and the inner bladder 30 is transversely compressed by the ambient pressure. Namely, the inner bladder 30 is not longitudinally deformed while in use, which is resulted from a sufficient longitudinally structural strength of the inner bladder 30. With the sufficient longitudinally structural strength, the inner bladder 30 may not be longitudinally deformed, so as to ensure the smooth flowing of the liquid out of the chamber 34.

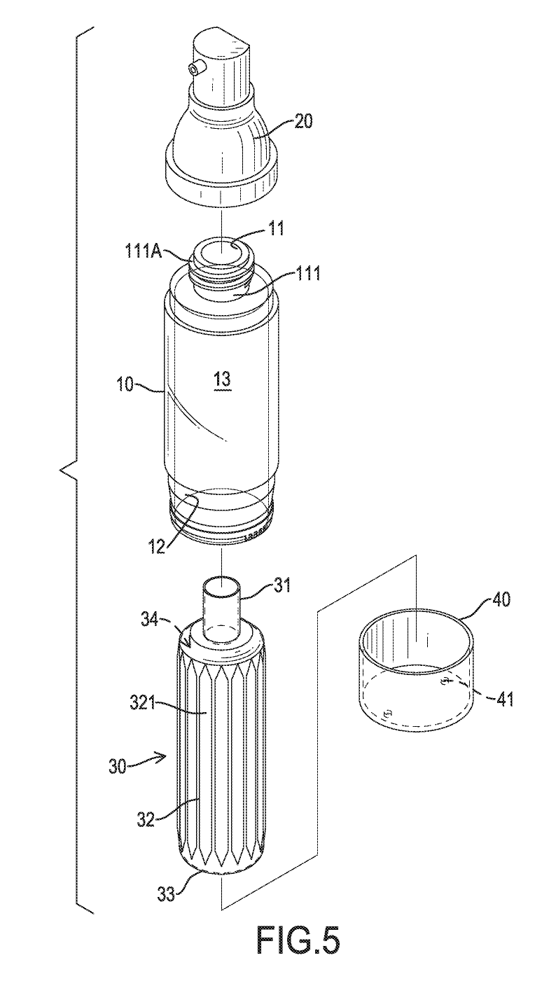

With reference to FIG. 5, in a second embodiment, an apparatus for containing and dispensing fluids under pressure in accordance with the present invention further comprises a bottom cover 40. The bottom cover 40 covers and closes the bottom opening 12. The bottom cover 40 may be, but not limited to, fitted or threaded with the bottle 10. The bottom cover 40 comprises two vent holes 41 for air to flow into the room 13 via the bottom opening 12. When the airless dispensing pump 20 is actuated, the air flows into the room 13 via the vent holes 41 to transversely compress the inner bladder 30, thereby enhancing the smooth flowing of the liquid out of the chamber 34.

Based on the above, with the combination of the inner bladder 30 and the airless dispensing pump 20, the liquid is stored in the chamber 34 of the one-piece inner bladder 30 without leaking out and being wasted. Since the conduit 22 is fixed with the bladder neck 31, the liquid in the chamber 34 is prevented from contacting and contaminated by bacteria in the ambient air, thereby maintaining the hygiene and stability of the liquid.

In addition, with the ribs 321 extending longitudinally between the bladder neck 31 and the bottom part 33, the inner bladder 30 is transversely compressed, instead of being longitudinally compressed, by the ambient pressure after the airless dispensing pump 20 is pushed. The inner bladder 30 is not recovered by the gravity after transversely compressed, thereby facilitating easy access to the liquid.

Further, the overall structure of the apparatus for containing and dispensing fluids under pressure is simple. The liquid may be dispensed without a piston. Thus, the manufacturing cost of the apparatus for containing and dispensing fluids under pressure is low, the profit of selling the cosmetic liquid is increased, and the resource is saved.

What is claimed is:

1. An apparatus for containing and dispensing fluids under pressure comprising:
a bottle comprising:
a top opening;
a bottom opening; and
a room connected between the top opening and the bottom opening;
an airless dispensing pump mounted on the top opening and fixedly connected with the top opening; and
an inner bladder disposed in the room and comprising:
a bladder neck connected with the airless dispensing pump;
a bottom part being sealed;
a peripheral part disposed between the bladder neck and the bottom part and comprising:
multiple ribs extending longitudinally between the bladder neck and the bottom part; and
a chamber surrounded by the bladder neck, the bottom part, and the peripheral part, wherein the bladder neck, the bottom part, and the peripheral part are formed as one piece.

2. The apparatus for containing and dispensing fluids under pressure as claimed in claim 1, wherein the airless dispensing pump comprises a conduit inserted into the room, fixed with the bladder neck, and inserted into the chamber.

3. The apparatus for containing and dispensing fluids under pressure as claimed in claim 1, wherein the apparatus for containing and dispensing fluids under pressure further comprises a bottom cover covering the bottom opening and including at least one vent hole, and each of the at least one vent hole is connected with the room.

4. The apparatus for containing and dispensing fluids under pressure as claimed in claim 2, wherein the apparatus for containing and dispensing fluids under pressure further comprises a bottom cover covering the bottom opening and including at least one vent hole, and each of the at least one vent hole is connected with the room.

5. The apparatus for containing and dispensing fluids under pressure as claimed in claim 1, wherein the inner bladder is made of a material that is plastic and thermostable.

6. The apparatus for containing and dispensing fluids under pressure as claimed in claim 4, wherein the inner bladder is made of a material that is plastic and thermostable.

7. The apparatus for containing and dispensing fluids under pressure as claimed in claim 1, wherein the ribs protrude away from the chamber.

8. The apparatus for containing and dispensing fluids under pressure as claimed in claim 6, wherein the ribs protrude away from the chamber.

9. The apparatus for containing and dispensing fluids under pressure as claimed in claim 1, wherein each of the ribs has a width gradually decreased from a middle section of each of the ribs towards the bladder neck and the bottom part.

10. The apparatus for containing and dispensing fluids under pressure as claimed in claim 8, wherein each of the ribs has a width gradually decreased from a middle section of each of the ribs towards the bladder neck and the bottom part.

11. The apparatus for containing and dispensing fluids under pressure as claimed in claim 1, wherein the bottle comprises a bottle neck surrounding the top opening, and the airless dispensing pump and the bottle neck are threaded together.

12. The apparatus for containing and dispensing fluids under pressure as claimed in claim 8, wherein the bottle comprises a bottle neck surrounding the top opening, and the airless dispensing pump and the bottle neck are threaded together.

13. The apparatus for containing and dispensing fluids under pressure as claimed in claim 11, wherein the bottle neck comprises an outer surface and an outer thread formed on the outer surface, the airless dispensing pump comprises an inner surface and an inner thread formed on the inner surface, and the inner thread matches the outer thread.

14. The apparatus for containing and dispensing fluids under pressure as claimed in claim 12, wherein the bottle neck comprises an outer surface and an outer thread formed on the outer surface, the airless dispensing pump comprises an inner surface and an inner thread formed on the inner surface, and the inner thread matches the outer thread.

15. The apparatus for containing and dispensing fluids under pressure as claimed in claim 1, wherein the bladder neck is mounted through the top opening, and the chamber is connected with the airless dispensing pump via the bladder neck.

16. The apparatus for containing and dispensing fluids under pressure as claimed in claim 14, wherein the bladder neck is mounted through the top opening, and the chamber is connected with the airless dispensing pump via the bladder neck.

17. The apparatus for containing and dispensing fluids under pressure as claimed in claim 1, wherein the bottom part is positioned in the bottom opening, and the bottom part has a shape matching a shape of the bottom opening.

18. The apparatus for containing and dispensing fluids under pressure as claimed in claim 16, wherein the bottom part is positioned in the bottom opening, and the bottom part has a shape matching a shape of the bottom opening.

19. The apparatus for containing and dispensing fluids under pressure as claimed in claim 16, wherein the bladder neck has a shape matching a shape of the top opening.

20. The apparatus for containing and dispensing fluids under pressure as claimed in claim 18, wherein the bladder neck has a shape matching a shape of the top opening.
